(19) United States
(12) Patent Application Publication
(10) Pub. No.: US 2002/0127460 A1
(43) Pub. Date: Sep. 12, 2002

(54) Protective coatings for fuel cell interconnect

(75) Inventors: Ai Quoc Pham, San Jose, CA (US); Brandon W. Chung, Dublin, CA (US); Robert S. Glass, Livermore, CA (US)

Correspondence Address: Alan H. Thompson, Assistant Laboratory Counsel, Lawrence Livermore National Laboratory, P.O. Box 808, L-703, Livermore, CA, 94551, US

(73) Assignee: The Regents of the University of California

(21) Appl. No.: 09/967,575

(22) Filed: Sep. 28, 2001

Related U.S. Application Data
(60) Provisional application No. 60/274,199, filed on Mar. 8, 2001.

(51) Int. Cl. H01M 8/02; B32B 15/01

(52) U.S. Cl. 429/34; 428/670; 428/672; 428/673

(57) ABSTRACT

A protective coating for fuel cell interconnects particularly for metal interconnects used in stacked solid oxide fuel cells, for preventing corrosion problems at high temperature. The protective coating is composed of precious metals such as platinum, palladium, and silver, which are highly conductive and are stable in both oxidizing and reducing atmosphere. While silver is the most economical, platinum and palladium have a high performance. Silver is cheap enough that its use in form of their film does not drive up the fuel cell costs significantly, and can be readily deposited on the metal interconnect using electrochemical techniques, such as electroplating.

### RELATED APPLICATION

This application relates to U.S. Provisional Application No. 60/274,199 filed Mar. 8, 2001, and claims priority thereof.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to fuel cell interconnects, particularly to metal interconnects for used in solid oxide fuel cell stacks, and more particularly to a protective coating for fuel cell interconnects from corrosion problems at high temperature.

The fuel cell interconnect is the component that allows to connect electrically the single cells in a fuel cell stack in order to generate voltage higher than 1 V. For planar fuel cell stack, the interconnect often serves also as the gas channels for both the fuel and air compartments. The interconnect must be stable in both oxidizing (air side) and reducing (fuel side) atmospheres, while being electrically conductive.

High temperature alloys that are oxidation resistant are the potential candidates for the interconnect material. Unfortunately, the requirement of being both oxidation resistant and electrically conductive is difficult to achieve because alloys that are oxidation resistant often have a protective layer composed of poorly conducting materials such as alumina or chromia. The thin protective layers are formed on the alloy surface when the material is heated to high temperature. Therefore, although the bulk of the alloy is still highly conductive, the oxide layer can be almost insulating, thus making the alloy unsuitable for use as fuel cell interconnect. Another issue that often comes up with oxidation resistant alloys that involved chromia protective layer is the high vaporization of chromia. At high temperature, the chromia vaporization can cause poisoning of the fuel cell electrodes and thus performance degradation.

A number of approaches have been proposed to enhance the interconnect surface conduction. Most approaches involve a coating of the metal surface with a protective layer that is electrically conductive. The protective layer is often made of (La, Sr)CrO₃ and/or the same material as the fuel cell electrode. (La, Sr)CrO₃ has low conductivity and is thus inadequate for fuel cells operating at temperatures lower than 800° C. The protective layer is usually deposited using plasma spraying or sputtering.

One of these prior approaches is disclosed in International Application WO 97/35349 (Badwal et al) published Sep. 25, 1997, which teaches a multilayer metal coating to protect essentially the anode side of cell only, with the multilayer coating excluding silver. Another prior approach is found in U.S. Pat. No. 6,054,231, issued Apr. 25, 2000 to A. V. Virbar et al, which teaches the coating of a metal that will react with chromium oxide coming from the surface of the metal interconnect, with the product of the reaction being a semiconductor that is more conductive than chromium oxide itself.

The present invention provides a solution to the interconnect corrosion problem by providing a protective layer on the metal interconnect of precious metals, such as platinum, palladium, rhodium, gold, and silver, which are highly conductive and are stable in both oxidizing and reducing atmospheres. The precious metal can be easily deposited on the metal interconnect using sputtering, or preferably low cost, high volume electrochemical techniques, such as electroplating or electroless deposition, and the entire interconnect can be coated or only areas that need to remain conductive (areas in contact with cell electrodes).

### SUMMARY OF THE INVENTION

It is an object of the present invention to provide a single protective coating for fuel cell interconnects.

A further object of the invention is to provide a method to protect metal interconnects used in a solid oxide fuel cells from corrosion problems at high temperature.

A further object of the invention is to provide a coating of a precious metal on at least electrical contact areas of metal interconnects.

Another object of the invention is to provide a protective coating of a precious metal on interconnects for intermediate temperature fuel cells (500-700° C.), as well as for high temperatures fuel cells (800° C.).

Another object of the invention is to provide at least the electrical contact areas of metal interconnects in a fuel cell stack, with a protective coating that has high-conductivity and is stable in both oxidizing and reducing atmospheres.

Another object of the invention is to provide metal interconnects for fuel cells with a single layer protective coating composed of a precious metal, such as platinum, palladium, rhodium, gold, and silver.

Other objects and advantages of the present invention will become apparent from the following description. Basically, the invention involves a protective coating for fuel cell interconnects. The invention enables a coating of the same material on both the air side and the fuel side of a fuel cell interconnect. The coating contains a precious metal which is both highly conductive and stable in both oxidizing and reducing atmospheres. From a performance standpoint gold, platinum or palladium are preferred, but silver is the most economical solution, in that silver is cheap enough that its use in the form of a thin film will not drive the fuel cell cost up significantly, and can be easily deposited on the metal interconnect using electrochemical techniques, such as electroplating. The plating can be done only on the areas of the interconnects that are in contact with the fuel cell electrodes, thus cutting down on the silver material cost.

### DETAILED DESCRIPTION OF THE INVENTION

The present invention involves the formation of a protective coating or layer for fuel cell interconnects. The method of protecting metal interconnects that are used in solid oxide fuel cell stacks, for example, from corrosion problems at high temperature, involve depositing a single layer of precious metal on the interconnect or at least on areas of the interconnect that are in contact with the cell electrodes. Precious metals, such as platinum, palladium, rhodium, gold, and silver are highly conductive and are stable in both oxidizing and reducing atmospheres, and thus a single coat of the same precious metal can be deposited on both the air side and the fuel side of the interconnect. The precious metal coatings can be utilized in high temperature fuel cells (800° C.) with a significant improvement in term of long-term stability. From a performance standpoint, gold, platinum or palladium are preferred, however, silver is the most economical solution. The resistance of samples without any coating increases rapidly with time, while the resistance for samples with a silver coating remained low for over 100 hours. However, due to the high volatility of silver at high temperatures, silver protection will not last very long at temperatures above 800° C. Tests have shown that silver degradation was observed after a few hundred of hours of operation, and thus another metal having a higher temperature degradation needs to be used at these higher (above 800° C.) temperatures. At reduced temperature, the volatility of silver is much reduced, resulting in longer stability, and therefore this technique using silver as the coating is best for intermediate temperature fuel cells (500-700° C.).

Silver can be easily deposited on the metal interconnect using, for instance, electroplating or another known electrochemical techniques. Since silver is relatively cheap, its use in the form of a thin film 0.01 to 100 microns preferably 0.1 to 25 microns will not drive up the fuel cell cost significantly. Also, plating only the areas of the interconnects that are in contact with the cell electrodes, cuts the cost of the silver.

It has thus been shown that the present invention enables the use of a single coating or layer of a metal on both the air and fuel sides of a metal interconnect for fuel cells. The single coating or layer contains a precious metal and deposited by electroplating, for example. The precious metal coating can be utilized for fuel cells operating in the 500-800° C. temperature range. While silver is the preferred precious metal because of its lower cost for temperature applications up to about 800° C., for temperatures over 800° C., other metals, such as gold, platinum and palladium, which are highly conductive and are stable in both oxidizing and reducing atmospheres, may be utilized. The coatings may also be used in fuel cells operating below 500° C. Thus, the single coating of a previous metal on metal interconnects for fuel cells has overcome the corrosion problems due to high temperatures.

While particular materials, thicknesses, etc., have been described to exemplify and teach the principles of the invention, such are not intended to be limiting. Modifications and changes may become apparent to those skilled in the art and it is intended that the invention be limited only by the scope of the appended claims.

The invention claimed is

1. In a fuel cell stack having at least one fuel cell interconnect, the improvement comprising:
said interconnect having a coating of precious metal at least on areas that are in contact with fuel cell electrodes.

2. The improvement of claim 1, wherein said coating covers substantially the entire outer surface of said interconnect.

3. The improvement of claim 1, wherein said precious metal is selected from the group of precious metals consisting platinum, palladium, rhodium, gold, and silver.

4. The improvement of claim 1, wherein said coating has a thickness in the range of 0.01 to 100 μm.

5. The improvement of claim 1, wherein said coating comprises a single layer of precious metal.

6. The improvement of claim 5, wherein said precious metal comprises silver.

7. The improvement of claim 6, wherein said silver coating is deposited on metal interconnects for fuel cells operating in the about 500-800° C. temperature range.

8. A metal interconnect for fuel cells having a coating of a metal which is highly conductive and stable in both oxidizing and reducing atmospheres, said coating covering at least areas of the metal interconnect to be in contact with electrodes of associated fuel cells.

9. The metal interconnect of claim 8, wherein the coating of a metal comprises a precious metal.

10. The metal interconnect of claim 9, wherein said precious metal is selected from the group consisting of platinum, palladium, rhodium, gold, and silver.

11. The metal interconnect of claim 8, wherein said coating consists of a single layer with a thickness of about 0.1 to 25 microns.

12. The metal interconnect of claim 8, in combination with fuel cells having an operating temperature in the range of about 500° C. to 800° C., and wherein said coating consists of silver.

13. The metal interconnect of claim 8, wherein said coating covers the entire interconnect.

14. A protective coating for fuel cell interconnects comprising a coating of a precious metal for preventing corrosion at all temperatures up to 800° C. or above.

15. The protective coating of claim 14, wherein said coating covers at least areas that are adopted to be in contact with electrodes of associated fuel cells.

16. The protective coating of claim 14, comprising a single layer of precious metal.

17. The protective coating of claim 16, wherein said precious metal is selected from the group consisting of platinum, palladium, rhodium, gold, and silver.

18. The protective coating of claim 17, wherein said precious metal comprises silver, and has a coating thickness of 0.01 to 100 microns.

19. The protective coating of claim 14, wherein said interconnects function to at least electrically interconnect a plurality of solid oxide fuel cells.

20. The protective coating of claim 14, wherein said coating covers an interconnect for fuel cells operating at temperature below 500.
